(19) United States
(12) Patent Application Publication
(10) Pub. No.: US 2026/0007495 A1
(43) Pub. Date: Jan. 8, 2026

(54) ABUTMENT FOR DENTAL BUILD-UP

(71) Applicant: Heinrich Steger, Sand in Taufers (IT)

(72) Inventor: Heinrich Steger, Sand in Taufers (IT)

(21) Appl. No.: 19/221,655

(22) Filed: May 29, 2025

(30) Foreign Application Priority Data
Jul. 8, 2024 (EP) 24187257.1

(51) Int. Cl. A61C 8/00

(52) U.S. Cl. CPC A61C 8/0068; A61C 8/008

(57) ABSTRACT

An abutment for dental build-up. The abutment is lockable to an implant body. The abutment has an opening with an introduction end and an exit end. A fixing screw in introducible via the introduction end. The screw portion of the fixing screw projects from the exit end. The screw portion is screwable with the implant body for locking. The opening has a tapering from the introduction end towards the exit end. In the locked state, the upper end of the screw head is at a distance from the introduction end. The abutment has a threaded portion. A locking element has a mating thread corresponding to the threaded portion for releasably connecting the locking element to the abutment. The locking element can be introduced into the opening via the introduction end and is releasably connectable to the threaded portion via the mating thread.

The present invention relates to an abutment for dental build-up, wherein the abutment is lockable to an implant body by means of a fixing screw, wherein the abutment has an opening with an introduction end and an exit end, wherein the fixing screw is introducible via the introduction end of the opening and wherein the screw portion of the fixing screw projects from the exit end and wherein the screw portion is screwable with a threaded portion of the implant body for locking. In addition, the invention relates to an implant system comprising an abutment, a fixing screw for connecting the abutment to an implant body, and optionally an implant body.

### BACKGROUND OF THE INVENTION

In general, implant systems serve for providing patients with dentures or dental restorations and thus for replacing lost teeth. According to the state of the art, dental restorations comprise an abutment, a fixing screw, and a supraconstruction. When providing patients with dental restorations, usually a form-fit connection between implant and dental restoration is formed in the mouth.

EP 3 721 829 A1 describes a tooth implant system having a thread in an abutment. However, this thread is an abutment extractor thread arranged at the height of the screw head. This thread only serves for unlocking the abutment from the implant without damage.

Furthermore, US 2013/0224689 A1 discloses an implant comprising an implant body and an abutment, wherein, on the one hand, the implant body is connected to the abutment by means of a clamper pin, while the abutment, on the other hand, has an internal thread into which a lock nut with an outer thread can be screwed to connect the abutment with the clamper pin.

In connecting procedures according to the state of the art, force effects may lead to loosening of the fixing screw that is meant to maintain a fixed connection between abutment and implant body. This loosening leads to damages of the restorations, requiring cost-intensive replacements of the restorations.

### BRIEF DESCRIPTION OF THE INVENTION

It is the object of the invention to provide an abutment for dental build-up in which the disadvantages mentioned above are reduced.

This object is achieved by an abutment for dental build-up, wherein the abutment is lockable to an implant body by means of a fixing screw, wherein the abutment has an opening with an introduction end and an exit end, wherein the fixing screw is introducible via the introduction end of the opening. When the fixing screw is fully introduced, the screw portion of the fixing screw projects from the exit end, so that the screw portion is screwable with a threaded portion of the implant body for locking. The opening of the abutment has a tapering from the introduction end towards the exit end so that a screw head of the fixing screw can be brought to abut, wherein in the locked state, the upper end of the screw head is at a distance from the introduction end, wherein the abutment has at least one threaded portion, wherein a locking element has a mating thread corresponding to the threaded portion for releasably connecting the locking element to the abutment, wherein the locking element can be introduced into the opening via the introduction end and is releasably connectable to the threaded portion via the mating thread.

An implant system is suitable for providing a patient with dentures, wherein the implant system comprises an implant body. The implant body, at the outer circumference of which a screw thread is formed, is inserted into the jawbone, wherein the implant body is preferably cylindrical in shape in order to facilitate introduction into the jaw. After implantation, an abutment is inserted into the implant body, which can be connected in a form-fit manner to the implant body by means of a fixing screw, wherein the fixing screw is screwed into a blind hole in the implant body.

For fixing with the fixing screw, the abutment has an opening. The opening has an introduction end and an exit end, wherein the exit end is the area facing the blind hole of the implant body. The fixing screw can be introduced via the introduction end, and via a screw portion of the fixing screw that projects from the exit end, the fixing screw can be screwed into a threaded portion in the area of the blind hole of the implant body for locking.

According to the invention, the opening of the abutment is tapered, i.e., the diameter of the opening is reduced section by section, wherein the tapering runs from the introduction end towards the exit end—i.e., the diameter is larger in the area of the introduction end than at the exit end. By means of this tapering, the screw head of the fixing crew can be brought to abut in the area of the tapering, and in the locked state, the abutment is wedged to the implant body with the fixing screw.

In the locked state, the upper end of the screw head is at a distance from the introduction end, so that the locking element can be introduced-preferably fully-into the introduction end. The abutment has at least one threaded portion by means of which the locking element can be releasably connected to a mating thread on the locking element corresponding to the threaded portion. Here, the threaded portion is arranged so that it is located in the area between the upper end of the screw head in its locked state and the introduction end, i.e., in the area of the distance.

In the connected state, the locking element is preferably arranged so that it abuts to the upper end of the screw head, which prevents the fixing screw from being released because an axial movement of the fixing screw (e.g., by unscrewing the screw connection at the implant body) is prevented. It may therefore be envisaged that the locking element, when connected to the abutment, abuts against the upper end of the screw head. Thus, loosening of the fixing screw can be impeded.

In addition, the locking element may have an installation portion to which a build-up part—e.g., for dentures or a dental restoration—can be connected. Here, the installation portion may be connectable to the build-up part in a form-fitting manner. Such a structure with an installation portion of the locking element allows for tapering of the screw channel.

The locking element is preferably fully introducible into the opening. Thus, the build-up height is kept to a minimum.

The threaded portion within the abutment may be left spiralized or right spiralized in order to allow for easier screwing.

In addition, the connection between abutment and locking element can be of the form-fitting and releasable type. This form-fitting type guarantees that the abutment is in a correct position with regard to the locking element.

The abutment and the locking element may, e.g., be made from titanium, a titanium alloy, zirconium ceramics or ceramics, but while the abutment and the locking element are not limited to any one of these materials, they are preferably formed from titanium or a titanium alloy.

The locking element preferably has a hexalobular socket, which allows the locking element to be screwed in with less wear and enables the transmission of a high torque.

In addition to the hexalobular socket, the locking element may have an installation portion, which allows for a form-fitting connection to a build-up part. Furthermore, the build-up part comprises an implant crown, the build-up part being, however, not limited to an implant crown.

Furthermore, the invention relates to an implant system comprising an abutment of the aforementioned manner with a locking element and a fixing screw, by means of which the abutment is preferably connectable to an implant body in a form-fitting manner. The implant system may, in addition, comprise an implant body.

### BRIEF DESCRIPTION OF THE DRAWINGS

Further details and advantages of the invention will be explained with reference to the figures and the description of the figures.

FIG. 1a, 1b show the abutment for dental build-up in a side view (FIG. 1a) and in a cross-section (FIG. 1b)

FIG. 2a, 2b show the abutment for dental build-up from FIG. 1a in an exploded view (FIG. 2a), including a cross-section of the exploded view (FIG. 2b)

### DETAILED DESCRIPTION OF THE INVENTION

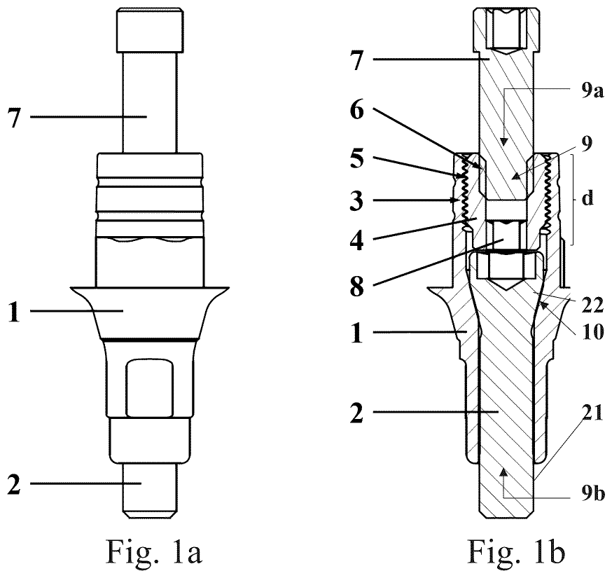

The views of FIG. 1a, 1b show the abutment 1 for dental build-up in a side view, on the one hand, and in a cross-section, on the other hand. By means of the fixing screw 2, the abutment 1 can be locked to an implant body not shown. For fixing, the abutment 1 has an opening 9 with an introduction end 9a and an exit end 9b. The fixing screw 2 is introduced via the introduction end 9a of the opening 9 so that the screw portion 21 of the fixing screw 2 projects from the exit end 9b. For locking, the screw portion 21 is, with a threaded portion, screwed into a blind hole of the implant body.

The opening 9 of the abutment 1 is tapered from the introduction end 9a towards the exit end 9b and thus has a tapering 10. In the area of the tapering 10, the screw head 22 of the fixing screw 2 can be brought to abut so that the abutment 1 is wedged to the implant body. In the locked state, the upper end 23 of the screw head 22 is at a distance d from the introduction end 9a. Thus, the locking element 4 can be introduced into the opening 9—via the introduction end 9a.

Just above (e.g., a few tenths of a millimeter) the screw head 22 of the fixing screw 2, the abutment 1 has a single- or multipart threaded portion 3, which is preferably formed as an inner thread. The threaded portion 3 is, on the one hand, arranged at the end of the abutment 1, wherein this end of the abutment 1 is arranged on the side facing away from the implant body. On the other hand, the threaded portion 3 is arranged at a certain distance from the screw head 22 of the fixing screw 2. In addition, the threaded portion 3 is formed as a single- or multipart and as an inner thread. The threaded portion 3 may also be formed in a left or right spiralized manner.

A mating thread 5 formed corresponding to the threaded portion 3—here as an outer thread—is part of the screw portion of the cylindrical locking element 4. By means of this mating thread 5, the threaded portion 3 of the abutment 1 can be screwed in. On the one hand, this results in a stable connection between the locking element 4 and the abutment 1. On the other hand, this connection impedes loosening of the fixing screw 2. The locking element 4 has a screw portion 5, formed as an outer thread, corresponding to the threaded portion 3. By means of the screw portion 5, the locking element 4 can be screwed into the threaded portion 3. The screw portion 5 of the locking element 4 does not extend over the entire height of the locking element 4.

The locking element 4 is introduced into the opening 9 via the introduction end 9a, and in the connected state, it abuts to the upper end 23 of the screw head 22, which may impede loosening of the fixing screw 2.

In addition, the locking element 4 has an installation portion 6, which can be connected, preferably in a form-fitting manner, to a build-up part 7.

In the screwed-in state, the locking element 4 acts as a lock screw that blocks potential loosening of the fixing screw 2. The abutment 1 limits the range of movement of the fixing screw 2 in two axial directions, and the locking element 4 limits its movement in a third axial direction.

Furthermore, the locking element 4 has an installation portion 6, into which a build-up part 7 may be introduced and which allows for tapering of the screw channel.

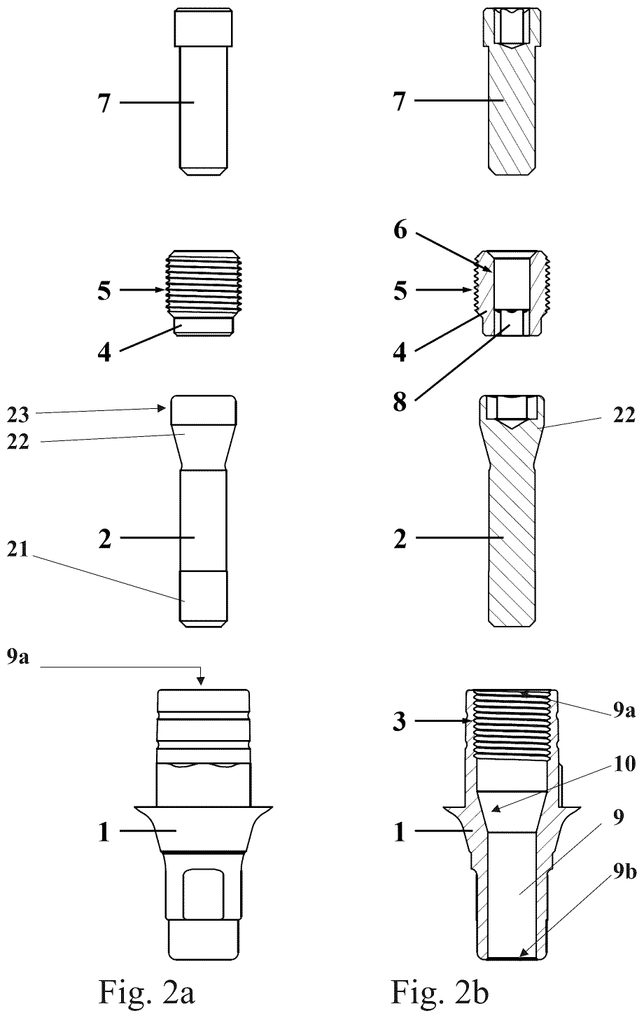

FIGS. 2a, 2b show perspective views in the form of an exploded view of the abutment 1 for dental build-up. It is clearly shown that the locking element 4 has a hexalobular socket 8 and is preferably cylindrical. The fixing screw 2 also preferably has a hexalobular socket 8.

1. An abutment for dental build-up,
wherein the abutment is lockable to an implant body by means of a fixing screw,
wherein the abutment has an opening with an introduction end and an exit end,
wherein the fixing screw is introducible via the introduction end of the opening and wherein a screw portion of the fixing screw projects from the exit end and wherein the screw portion is screwable with a threaded portion of the implant body for locking,
wherein the opening of the abutment has a tapering from the introduction end towards the exit end so that a screw head of the fixing screw can be brought to abut in an area of the tapering, wherein, in a locked state, an upper end of the screw head is at a distance from the introduction end,
wherein the abutment has at least one threaded portion,
wherein a locking element has a mating thread corresponding to the threaded portion for releasably connecting the locking element to the abutment,
wherein the locking element can be introduced into the opening via the introduction end and is releasably connectable to the threaded portion via the mating thread.

2. The abutment according to claim 1, wherein the locking element has an installation portion for connection to a build-up part.

3. The abutment according to claim 2, wherein the installation portion is connectable to the build-up part in a form-fitting manner.

4. The abutment according to claim 1, wherein the locking element, in its state connected to the abutment, abuts to the upper end of the screw head.

5. The abutment according to claim 1, wherein the threaded portion is formed as an inner thread and the mating thread is formed as an outer thread corresponding to the threaded portion.

6. The abutment according to claim 1, wherein the threaded portion is formed in a left spiralized or right spiralized manner.

7. The abutment according to claim 1, wherein the locking element can be connected to the abutment in a form-fitting manner.

8. The abutment according to claim 1, wherein the locking element has a hexalobular socket.

9. The abutment according to claim 1, wherein an installation portion comprises a recess, wherein a diameter of the recess is smaller than a largest diameter of the opening.

10. The abutment according to claim 9, wherein the diameter of the recess is smaller than a smallest diameter of the opening.

11. The abutment according to claim 2, wherein the build-up part comprises an implant crown.

12. An implant system, comprising:
an abutment according to claim 1, and
a fixing screw by means of which the abutment can be connected to an implant body in a form-fitting-manner.

13. The implant system according to claim 12, further comprising an implant body.
